(19) United States
(12) Patent Application Publication
(10) Pub. No.: US 2010/0242845 A1
(43) Pub. Date: Sep. 30, 2010

(54) Udder spraying apparatus

(76) Inventor: James Frederick Pharaoh, Hamilton (NZ)

Correspondence Address: JACOBSON HOLMAN PLLC, 400 SEVENTH STREET N.W., SUITE 600, WASHINGTON, DC, 20004, US

(21) Appl. No.: 12/656,910

(22) Filed: Feb. 18, 2010

(30) Foreign Application Priority Data
Feb. 19, 2009 (NZ) 575037

(51) Int. Cl. A01J 5/00; A01J 5/003

(52) U.S. Cl. 119/14.04; 119/14.18

(57) ABSTRACT

An udder spraying system reliant on one or more upward spray outlet(s) from and/or in juxtaposition with a housing and/or profile providing moulding or form;

The present invention relates to udder spraying whether pre-milking, post-milking, or both.

It is usual to wash udders prior to milking. Increasingly sprays have been used for such pre-milking washing. It has also been common for post-milking spraying.

Generally any such pre or post-milking spraying systems have involved wands with nozzles handled manually or robotically. Most common has been off platform or out of bail apparatus (robotic or not) which is to cover the udder area.

We have determined that on a milking platform, rotary or otherwise, it is possible in the stall or bail area (irrespective of whether or not there is appropriate fencing barriers or the like) to provide spraying upwardly to the zone of the udder.

More particularly, although not solely, we have determined that two nozzles or more than two nozzles spaced longitudinally with respect to an animal to be sprayed has a capability, as a result of on udder merging of the spray pattern (eg, whether by lapping or tessellation of the spray patterns) to ensure adequate coverage taking account of such variables as longitudinal positioning by and movement of the animal in the stall or bail area, the size of the individual animal, the height of the udders of the particular animal, etc.

We have determined that a spray pattern accumulation of the individual spray pattern of at least two spray outlets spaced longitudinally with respect to the animal's longitudinal axis can be sufficient to ensure effective spraying provided appropriate pressures and nozzle types are chosen.

We have also determined that there is an advantage in any spray outlet from the platform and/or stall or bail to ensure little tendency for the animal to stand on or adjacent the nozzle. We have determined an advantage in providing a profile unlikely to stably support the animal's foot and to encourage some degree of leg spreading.

We are aware that leg spreading profiles previously have been utilised for use in conjunction with manual spraying or off platform spraying apparatus. There has been no suggestion however of an ability to provide a fitment of a plumbed or plumbable profile to the floor of a bail or stall, or other incorporation of spray nozzles, so as to accomplish direct spraying of the udder of an animal from more or less directly underneath the udder.

We have also determined that it is possible with a moulded housing able to receive spray outlets and to be plumbed to provide for easy fitment of such an assembly on to a suitable support surface (such as the platform of a rotary platform or the platform of a step up or herringbone stall or bail). In the latter case, there might not be discrete barriers between individual animals.

Reference there to “platform” is not necessarily restricted to rotary platforms.

Preferably the platform is an annular rotary platform.

It is an object of the present invention to provide apparatus, systems, procedures, methods, assemblies etc which will at least go some way to providing an alternative to existing spraying arrangements.

It is a further or alternative object to provide for automatic teat spraying on a rotary platform and/or apparatus able to retrofit such platforms, etc.

In an aspect the invention is a milking facility of a kind having a rotary milking platform wherein there is, for each milking position (eg, stall, bail or other) on the platform, one or more spray outlets physically associated by proximity to and/or nozzle dependence from an on platform supported housing and/or leg spreading profile.

Preferably there are at least two nozzles per milking position at least one substantially radially spaced from the other.

Preferably a moulding fixed to said platform for each milking position mounts two nozzles able to ensure a sufficient spread of spray (eg, a Figure “8” spread) to accommodate animal of same type variation in characteristics.

In another aspect the invention is, in combination, subassembly or assembly,

a housing able to receive a plumbed feed or plumbed feeds of fluid(s)

a first nozzle mounted from said housing to receive and spray said fluid(s) in use, and

at least a second nozzle mounted from said housing to receive and spray said fluid(s) in use.

Preferably said housing is a moulding.

Preferably said housing is attachable (eg, by adhesive and/or otherwise) to, or attached to, a rotary milking platform so as to have said nozzles at least substantially radially aligned on the platform, one relative to the other, and to direct fluid(s) upwardly.

Preferably the housing, when in se, has a profile such that it will act as a leg spreader for the rear legs of an animal to be sprayed and/or milked.

Preferably a scallop like depression in that profile allows more room over the moulding for cluster application to, retention on, and/or detachment from an udder of a sprayed, milking and/or to be sprayed udder.

In an aspect the invention is apparatus of any of the kinds herein described by reference to any one or more of the accompanying drawings or related systems, uses, methods, procedures, plant, facilities, or the like.

In an aspect the invention is a moulding suitable for attachment to a rotary milking platform, able to act as a rear leg spreader and/or able to accommodate at least two spray nozzles, each to direct a spray pattern upwardly, with a cumulative greater radial than circumferential spread, at udder height, with respect to the rotary platform.

The moulding is preferably as hereinafter described and/or shown.

In an aspect the invention is a moulding suitable for attachment to a rotary milking platform, able to act as a rear leg spreader and/or able to accommodate at least two spray nozzles, each to direct a spray pattern upwardly, with a cumulative greater radial than circumferential spread, at udder height, with respect to the rotary platform.

The moulding is preferably as hereinafter described and/or shown.

In an aspect the invention is the use of a leg spreader profile or profiles on a milking platform as mounting(s) for upwardly directed spray nozzles for udder spraying purposes.

In an aspect the invention is an assembly providing one or more, on platform, and/or, from the bail, udder spraying outlets.

Preferably there are two nozzles as outlets preferably spaced longitudinally with respect to an animal to be milked.

Preferably at least one or more of said outlet(s) is(are) from a profile discouraging of stable animal foot placement.

Preferably said at least one or more said outlet(s) is(are) from and/or in juxtaposition to a profile or profiles.

Preferably said profile(s) house(s) at least in part a nozzle of each outlet. Preferably said profile or profiles is a leg spreading nozzled assembly.

In an aspect the invention is from udder spraying apparatus resulting from, in bail, and/or, on platform, placement of a plumbed and/or plumbable housing.

In an aspect the invention is udder spraying apparatus resulting from, in bail, and/or, on platform, placement of a plumbed and/or plumbable nozzled housing having a leg spreading profile.

In an aspect the invention is udder spraying apparatus resulting from, in bail, and/or, on platform, placement of a plumbed and/or plumbable housing having two or more spray nozzles spaced so as to be spaced longitudinal of the animal to be sprayed.

In an aspect the invention is udder spraying apparatus resulting from, in bail, and/or, on platform, placement of a plumbed and/or plumbable housing, the housing having two spray nozzles, a profile to spread the animal's legs yet to allow cluster fitment to the animal's udder.

In an aspect the invention is udder spraying apparatus resulting from, in bail, and/or, on platform, placement of a plumbed and/or plumbable housing,

wherein the housing is configured to support two or more spaced spray nozzles so as to be spaced longitudinally of the animal to be sprayed (and preferably having on to each flank of the axis provided by that spacing of the nozzles a surface on to which an animal's hoof can not be stably supported, and/or preferably having on the axis of the spaced nozzles from a direction from which a cluster is to be moved for fitment to the animal's udder a recess).

Preferably said recess is in the form of a scallop.

Preferably the flanking profiles can include a separate scallop, ramp or the like form.

In an aspect the invention is, during a milking of an animal using a milking platform, pre-cluster application and/or post cluster removal spraying the udder using one or more upwardly directed spray nozzles from and/or associated with a leg spreading mount, form or housing.

In an aspect the invention consists in, from within the milking stall or bail area, an upward projection of an udder spray.

Preferably two or more spray patterns are to merge on the udder of an animal to be sprayed.

In an aspect the invention consists in, from within the milking stall or bail area, an upward projection of an udder spray from plural spray outlets.

In an aspect the invention consists in, from within the milking stall or bail area, an upward projection of an udder spray from one or more spray outlets associated with a leg spreading profile.

In an aspect the invention consists in, from within the milking stall or bail area, an upward projection of an udder spray from at least two spray nozzles spaced apart longitudinally of an animal to be sprayed.

In an aspect the invention consists in, from within the milking stall or bail area, an upward projection of an udder spray from a retrofitted plumbed or plumbable housing.

In an aspect the invention is an udder spraying system reliant on one or more upward spray outlet(s) from and/or in juxtaposition with a housing and/or profile providing moulding or form.

In an aspect the invention is an udder spraying system reliant on one or more upward spray outlet(s) from and/or in juxtaposition with a housing and/or profile providing moulding or form;

wherein the housing or moulding or form is profiled to spread or hold apart (“spread”) legs of an animal to be sprayed.

In an aspect the invention is an udder spraying system reliant on two or more upward spray outlets preferably from a common housing.

Preferably the housing is adapted to spread the rear legs to the targeted animal.

Preferably the housing is profiled to allow cluster movement between the housing and the animal.

In an aspect the invention is an udder spraying system reliant on two or more upward spray outlets from a leg spreading moulded housing, the spray outlets to merge or tessellate their patterns on a targeted udder, or otherwise spread sufficiently, such that animal longitudinal movement, animal size, animal udder height, etc will not prevent at least one spray outlet's spread finding its target.

In an aspect the invention is a rotary milking platform having a nozzle array of at least two nozzles to spray upwardly from under and/or nearly under the udder of a cow to be milked and/or just milked on the platform.

Preferably there is a rear leg spreading form on the platform.

As used herein the term “and/or” means “and” or “or”, or both.

As used herein the term “(s)” following a noun includes, as might be appropriate, the singular or plural forms of that noun.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

A preferred form of the present invention will now be described in which

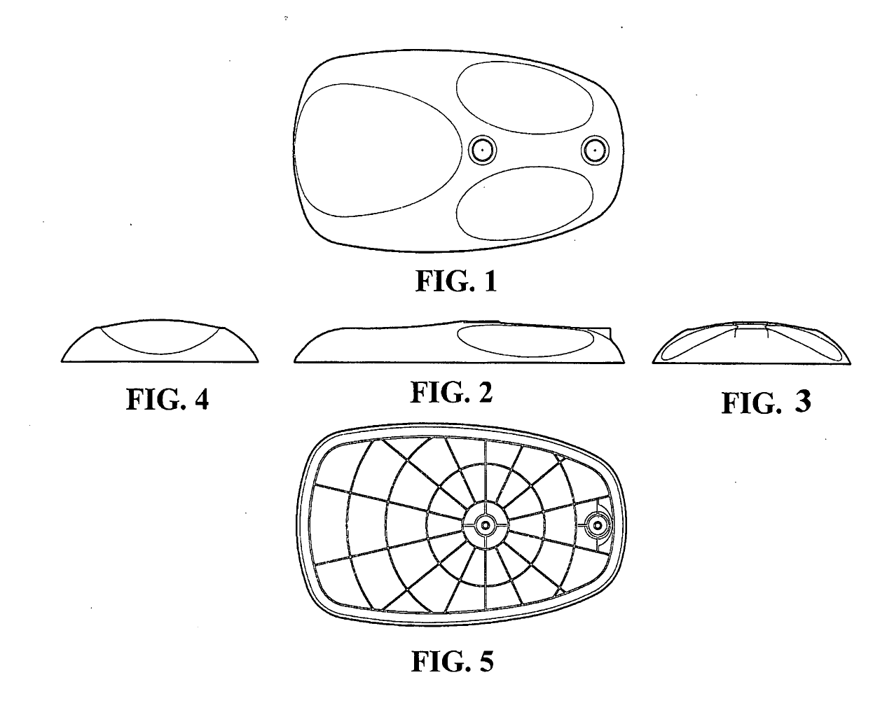

FIG. 1 is a plan view of an injection moulding in accordance with the present invention able to act as a mount or housing for two spaced upwardly directed spray nozzles, the line between the spray nozzles to be in a vertical plane substantially radially of a rotary milking platform, there being three scallop like forms, one to either side of the nozzles to assist in leg spreading and another scallop like form to an outward direction able to assist in providing space for cluster movement and placement on the udder,

FIG. 2 is a side elevation of the assembly of FIG. 1,

FIG. 3 is the inward elevation of the assembly of FIGS. 1 and 2,

FIG. 4 is the outward elevation of the assembly of FIGS. 1 to 3,

FIG. 5 is a view from below (base view) of the assembly of FIGS. 1 to 4 but not showing plumbing,

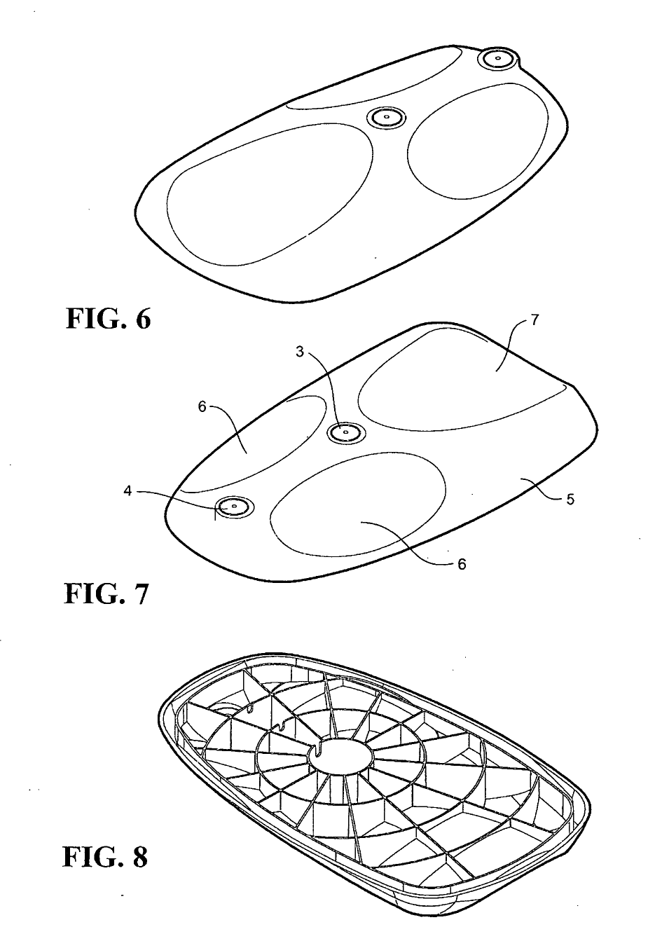

FIG. 6 is an isometric or perspective view of the arrangement of FIGS. 1 to 5 from a more outward direction,

FIG. 7 is a similar view to that of FIG. 6 but rotated,

FIG. 8 is a perspective or isometric view from below of the arrangement of FIGS. 1 to 7,

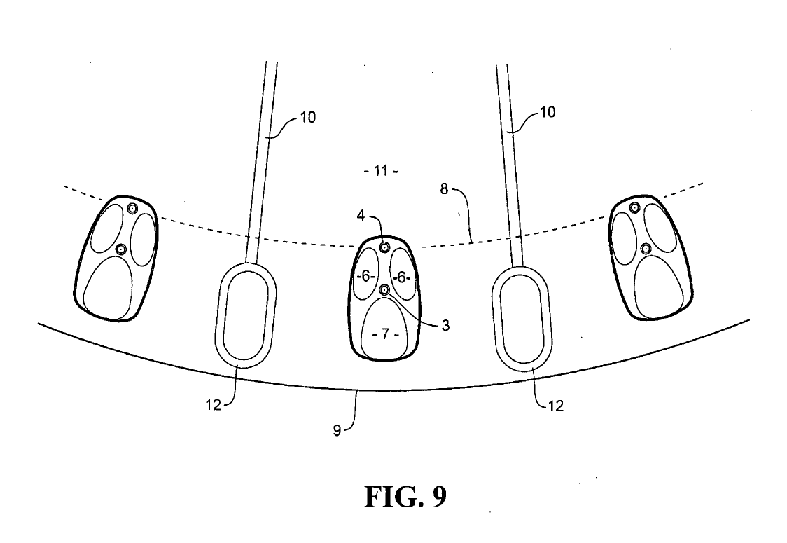

FIG. 9 is a plan view of part of a rotary platform showing the assemblies of FIGS. 1 to 8 in place in the circumferentially spaced milking positions on the platform ie, preferably more outwardly on each stall or bail but substantially radially aligned (with respect to the annular platform) in so far as the nozzles are concerned,

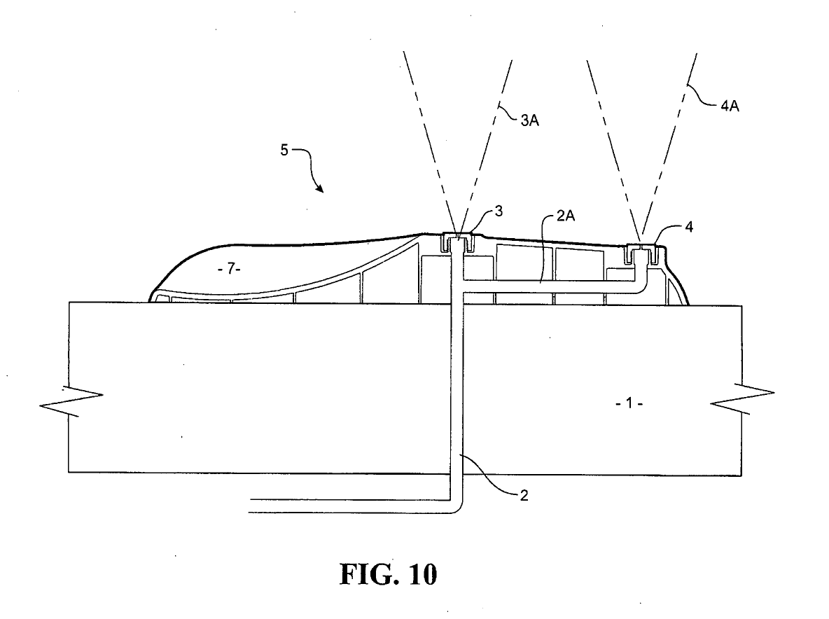

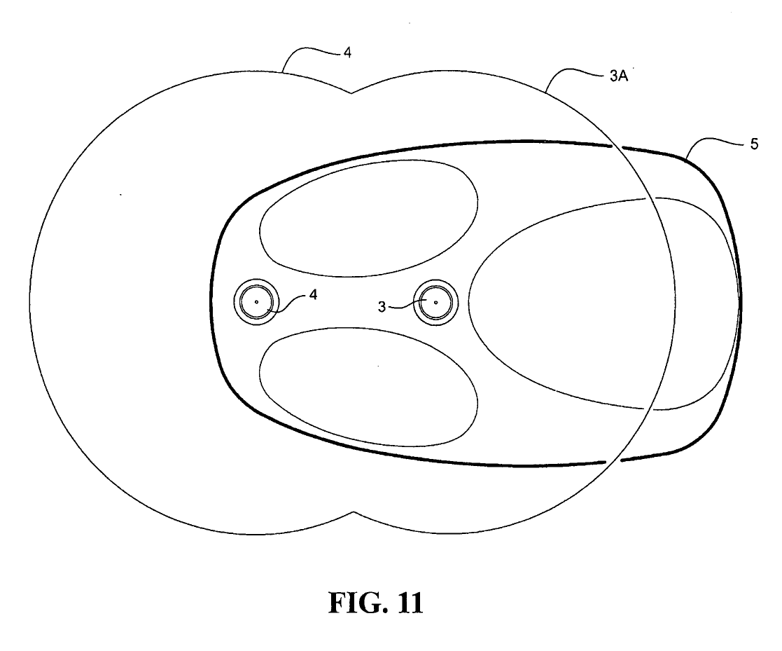

FIG. 10 is a cross section through the spray nozzles of an arrangement of FIG. 9, when appropriately plumbed for a cleaning fluid supply to the nozzles, showing upwardly directed complementary spray cones from the plumbed in nozzles mounted from or relative to a moulding fixed to the deck, concrete, fibreglass, steel, aluminium or otherwise,

FIG. 11 is a plan view similar to FIG. 1 but showing the merged spray coverage (eg, Figure “8”) at the level of a target udder,

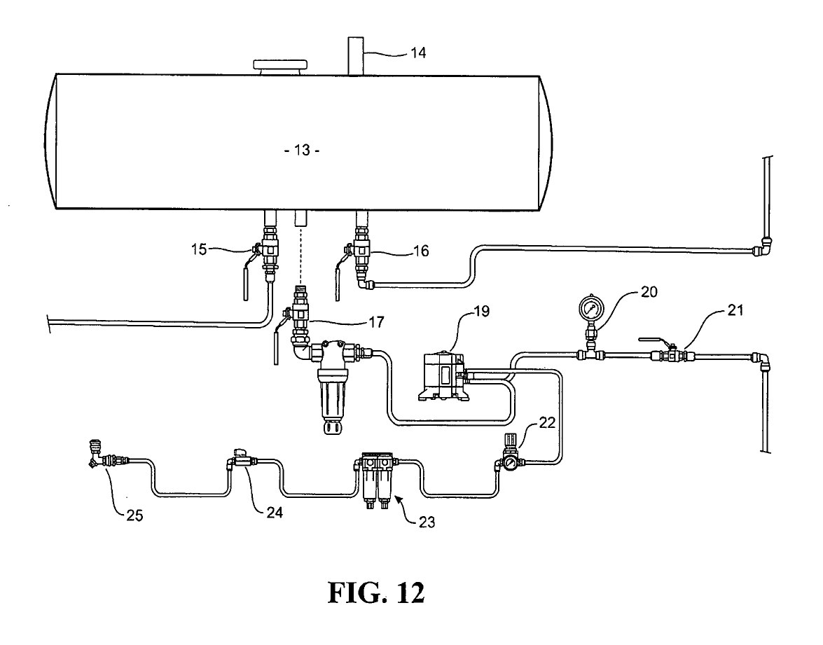

FIG. 12 is a spray tank assembly as might be used with the spraying apparatus of the invention, and

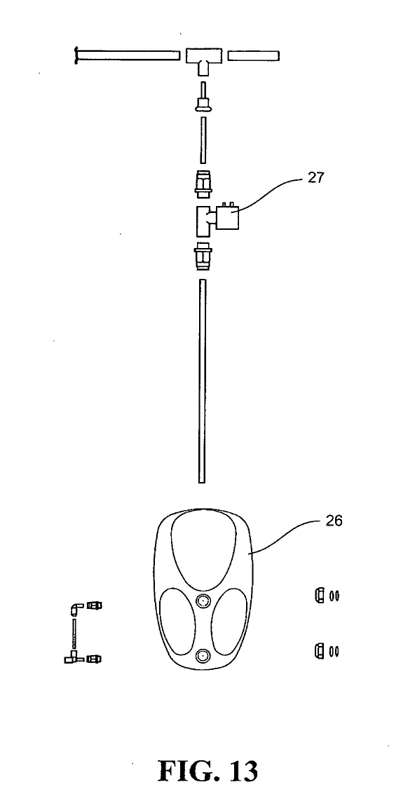

FIG. 13 is an exploded view of components to be assembled for each bail.

Preferred forms of the present invention will now be described with reference to a rotary platform such as that supplied by our affiliate Rotary Platforms NZ Limited. The apparatus of the present invention can be used in conjunction with such platforms whether of concrete, steel, aluminium, or other material (for example fibre-glass) when fitted out with any suitable milking machinery including that marketed under our WAIKATO™ branding.

We envisage (see FIG. 10) under deck 1 plumbing 2 to at least two nozzles 3 and 4 mounted from a moulding 5 such that their cones of spray 3a and 4a respectively provide coverage at udder height substantially as shown in FIG. 11.

FIG. 7 shows the moulding 5. This is preferably of, for example, a polycarbonate or a polycarbonate blend. Other suitable materials can be used. Indeed it is even possible for it to be of a metal or other form. Ideally however it is an easily mouldable plastics material.

The moulding 5 preferably has recesses adapted to locate, for plumbing purposes, the nozzles 3 and 4. These can be any suitable nozzle type, (metal, plastic, etc) having a cone or other spraying pattern suitable for the purpose.

The moulding 5 has on each flank preferably scallop-like forms to discourage foot placement at or adjacent either nozzle. These scallop forms 6 are two of three scallop forms. The third one 7 is preferably positioned at the outward end region so as to better enable movement of the milking cluster to the udder without interference from the moulding 5.

In the arrangement shown there is a webbing as part of the bottom of the mould 5 so as to confer strength. This webbing is preferably such as not to preclude plumbing 2 as shown. Indeed the plumbing 2 preferably has a branch line 2a to the more inward nozzle 4 located in the recess shown in FIG. 10 of the moulding 5.

The broken line of FIG. 9 designated 8 is preferably the main reticulation line for the fluids under the decking from which a feed, substantially as shown in FIG. 10, can be taken.

Any suitable spacing depending on spray pattern type can be provided between the two nozzles 3 and 4. Suitable spacings include anything from say, 80 to 250 mm. A particularly preferred spacing is of the order of about 150 mm. This is particularly so where the moulding is substantially as shown having a greatest width of the order of about 260 mm and a depth in the radial direction of the platform or about 440 mm.

The preferred height of the formation provided by the assembly can be from for example 30 to 90 mm high. Preferably however the maximum height is of the order of about 55 mm.

If need be platform recesses can allow flush or lower height fitment of spray nozzles.

It is envisaged that a suitable placement on a platform a in FIG. 9 has the nozzle 3 positioned inwardly from the platform's exterior perimeter 9 at a distance of from 250 mm to 550 mm. A suitable distance is about 355 mm.

FIG. 9 shows barriers 10 flanking the milking position 11 or the stall or bail 11 and showing how there can be service cabinets 12 at the outward end near the perimeter 9.

A feature of the preferred embodiment is the provision of two nozzles. More than two nozzles can be used. In less preferred forms of the present invention a single nozzle can be used. A single nozzle if used should have a greater spread radially of the platform than circumferentially of the platform.

It is however a highly preferred feature of the present invention that there is a leg spreading formation on the platform from which one nozzle or at least one of the nozzles is mounted and preferably both or all of the nozzles.

The spray tank assembly is shown in FIG. 12. The tank 13 is preferably suspended from ribs of the platform e.g. as described and claimed in NZ Patent 551609 of Rotary Platforms NZ Limited. A tank is appropriate to allow premixing of the cleaning agents that might be used.

FIG. 12 shows the following:
13—the tank
14—the tank fill inlet
15—a valve to drain
16—a valve regulator
17—an outlet valve
18—a filter
19—a pump (electric or more preferably compressed air driven using the air compressor of the platform)
20—a pressure gauge
21—a valve
22—a regulator
23—filters
24—ball valve
25—“Y” connector

FIG. 13 shows an exploded view of the fittings to the housing moulding 26. While largely reticulating the sprayable liquid to the nozzles via, say, 6 mm diameter plastic tubing and including a solenoid control at 27, preferably assembly and use is as set out in our SMARTSPRAY™ installation manual published late 2009.

The system preferably operates at about 3 bar and preferably does not exceed 4 bar. Preferably a spray pump rated to, say, 19 litres/minute at 20 bar is used in conjunction with the pressure regulators. A suitable tank may hold 120 litres or more.

By way of example, at a spray rate of 12 ml per nozzle per cow, (24 ml per activation) and a through put of 800 cows, the system will use 19.2 litres of spray per milking.

1. A milking facility of a kind having a rotary milking platform wherein there is, for each milking position on the platform, one or more spray outlets physically associated by proximity to and/or nozzle dependence from an on platform supported housing and/or leg spreading profile.

2. The facility of claim 1 wherein in there are at least two nozzles per milking position at least one substantially radially spaced from the other.

3. The facility of claim 2 wherein a moulding fixed to said platform for each milking position mounts two nozzles able to ensure a sufficient spread of spray to accommodate animal of same type variation in characteristics.

4. In combination, subassembly or assembly,
a housing able to receive a plumbed feed or plumbed feeds of fluid(s)
a first nozzle mounted from said housing to receive and spray said fluid(s) in use, and
at least a second nozzle mounted from said housing to receive and spray said fluid(s) in use.

5. The apparatus of claim 4 wherein said housing is a moulding.

6. The apparatus of claim 4 wherein said housing is attachable to, or attached to, a rotary milking platform so as to to have said nozzles at least substantially radially aligned on the platform, one relative to the other, and to direct fluid(s) upwardly.

7. The apparatus of claim 4 wherein the housing, when in use, has a profile such that it will act as a leg spreader for the rear legs of an animal to be sprayed and/or milked.

8. The apparatus of claim 7 wherein a scallop like depression in that profile allows more room over the moulding for cluster application to, retention on, and/or detachment from an udder of a sprayed, milking and/or to be sprayed udder.

9. (canceled)

10. A moulding suitable for attachment to a rotary milking platform, able to act as a rear leg spreader and/or able to accommodate at least two spray nozzles, each to direct a spray pattern upwardly, with a cumulative greater radial than circumferential spread, at udder height, with respect to the rotary platform.

11. The moulding of claim 10 ubstantially as herein described and/or shown.

12. A moulding suitable for attachment to a rotary milking platform, able to act as a rear leg spreader and/or able to accommodate at least two spray nozzles, each to direct a spray pattern upwardly, with a cumulative greater radial than circumferential spread, at udder height, with respect to the rotary platform.

13. (canceled)

14. A use of a leg spreader profile or profiles on a milking platform as mounting(s) for upwardly directed spray nozzles for udder spraying purposes.

15. An assembly providing one or more, on platform, and/or, from the bail, udder spraying outlets.

16. The assembly of claim 15 wherein there are two nozzles as outlets.

17. The assembly of claim 16 wherein the outlets are spaced longitudinally with respect to an animal to be milked.

18. The assembly of claim 16 wherein at least one or more of said outlet(s) is(are) from a profile discouraging of stable animal foot placement.

19. The assembly of claim 16, wherein said at least one or more said outlet(s) is(are) from and/or in juxtaposition to a profile or profiles.

20. The assembly of claim 19 wherein said profile(s) house(s) at least in part a nozzle of each outlet.

21. The assembly of claim 20 wherein said profile or profiles is a leg spreading nozzled assembly.

22. An udder spraying apparatus resulting from, in bail, and/or, on platform, placement of a plumbed and/or plumbable housing.

23. An udder spraying apparatus resulting from, in bail, and/or, on platform, placement of a plumbed and/or plumbable nozzled housing having a leg spreading profile.

24. An udder spraying apparatus resulting from, in bail, and/or, on platform, placement of a plumbed and/or plumbable housing having two or more spray nozzles spaced so as to be spaced longitudinal of the animal to be sprayed.

25. An udder spraying apparatus resulting from, in bail, and/or, on platform, placement of a plumbed and/or plumbable housing, the housing having two spray nozzles, a profile to spread the animal's legs yet to allow cluster fitment to the animal's udder.

26. In an aspect the invention is udder spraying apparatus resulting from, in bail, and/or, on platform, placement of a plumbed and/or plumbable housing,
wherein the housing is configured to support two or more spaced spray nozzles so as to be spaced longitudinally of the animal to be sprayed and preferably having on to each flank of the axis provided by that spacing of the nozzles a surface on to which an animal's hoof can not be stably supported, and/or preferably having on the axis of the spaced nozzles from a direction from which a cluster is to be moved for fitment to the animal's udder a recess.

27. The apparatus of claim 26 wherein said recess is in the form of a scallop.

28. The apparatus of claim 26 wherein the flanking profiles includes a separate scallop, ramp or the like form.

29. During a milking of an animal using a milking platform, pre-cluster application and/or post cluster removal spraying of the animal's udder using one or more upwardly directed spray nozzles from and/or associated with a leg spreading mount, form or housing.

30. From within the milking stall or bail area, an upward projection of an udder spray.

31. The projection of claim 30 wherein two or more spray patterns are to merge on the udder of an animal to be sprayed.

32. From within the milking stall or bail area, an upward projection of an udder spray from plural spray outlets.

33. From within the milking stall or bail area, an upward projection of an udder spray from one or more spray outlets associated with a leg spreading profile.

34. From within the milking stall or bail area, an upward projection of an udder spray from at least two spray nozzles spaced apart longitudinally of an animal to be sprayed.

35. From within the milking stall or bail area, an upward projection of an udder spray from a retrofitted plumbed or plumbable housing.

36. An udder spraying system reliant on one or more upward spray outlet(s) from and/or in juxtaposition with a housing and/or profile providing moulding or form.

37. An udder spraying system reliant on one or more upward spray outlet(s) from and/or in juxtaposition with a housing and/or profile providing moulding or form;
wherein the housing or moulding or form is profiled to spread or hold apart legs of an animal to be sprayed.

38. An udder spraying system reliant on two or more upward spray outlets from a common housing.

39. The system of claim 38 wherein the housing is adapted to spread the rear legs to the targeted animal.

40. The system of claim 39 wherein the housing is profiled to allow cluster movement between the housing and the animal.

41. An udder spraying system reliant on two or more upward spray outlets from a leg spreading moulded housing, the spray outlets to merge or tessellate their patterns on a targeted udder, or otherwise spread sufficiently, such that animal longitudinal movement, animal size, animal udder height, etc will not prevent at least one spray outlet's spread finding its target.

43. A rotary milking platform having a nozzle array of at least two nozzles to spray upwardly from under and/or nearly under the udder of a cow to be milked and/or just milked on the platform.

43. The platform of claim 42 wherein there is a rear leg spreading form on the platform.
